(19) United States
(12) Patent Application Publication
(10) Pub. No.: US 2014/0003610 A1
(43) Pub. Date: Jan. 2, 2014

(54) METHOD OF REPRODUCING SOUND SOURCE OF TERMINAL AND TERMINAL THEREOF

(71) Applicant: SAMSUNG ELECTRONICS CO., LTD., Gyeonggi-do (KR)

(72) Inventors: Dohyeon KIM, Gyeonggi-do (KR); Donghyuk Lee, Seoul (KR); Dongchang Lee, Gyeonggi-do (KR); Wonsuk Chang, Gyeonggi-do (KR)

(73) Assignee: Samsung Electronics Co., Ltd., Gyeonggi-do (KR)

(21) Appl. No.: 13/891,900

(22) Filed: May 10, 2013

(30) Foreign Application Priority Data
Jun. 28, 2012 (KR) 10-2012-0069704

(51) Int. Cl. H04R 3/00

(52) U.S. Cl. CPC H04R 3/00
USPC 381/61

(57) ABSTRACT

A terminal and a method of reproducing a sound source which changes a reproducing attribute of a sound source based on input information and reproduced the changed sound source to provide an effect sound are provided. The method of reproducing a sound source, includes detecting generation of an input; extracting at least one sampling point with respect to the input while the input continues; analyzing input information based on the at least one sampling point; determining a reproducing attribute with respect to a sound source corresponding to the input information based on the input information; and reproducing the sound source corresponding to the input information according to the determined reproducing attribute.

### PRIORITY

This application claims priority under 35 U.S.C. §119(a) to an application filed in the Korean Intellectual Property Office on Jun. 28, 2012, and assigned Application No. 10-2012-0069704, the contents of which are incorporated herein by reference.

### BACKGROUND OF THE INVENTION

1. Field of the Invention

The present invention relates generally to a method of reproducing a sound source of a terminal and a terminal thereof, and more particularly, to a method of reproducing a sound source which changes a reproducing attribute of a sound source based on input information and reproducing the changed sound source to provide an effect sound, and a terminal thereof.

2. Description of the Related Art

In general, when user input is generated, a terminal such as a smart phone or a tablet PC provides a suitable effect sound. For example, upon starting touch input, the terminal starts reproducing a sound source with respect to an effect sound. Upon termination of the touch input, the terminal terminates reproducing the sound source.

However, provision of a current effect sound is a simply repeated output of the same sound source only. Accordingly, the effect sound does not vary. Therefore, in order to provide various effect sounds, various types of sound sources are prepared and are separately reproduced.

Since a preceding operation necessary to reproduce the sound source must be performed upon provision of the effect sound, a delay occurs so that reproduction in real time of the effect sound is not reflected and the correspondence between an input and the effect sound is lost.

### SUMMARY OF THE INVENTION

The present invention has been made to address at least the above problems and disadvantages, and provides at least the advantages described below. In accordance with an aspect of the present invention, a method of reproducing a sound source of a terminal which changes a reproducing attribute of the sound source with respect to an effect sound based on touch input information and reproduces the changed sound source, and a terminal thereof, are provided.

The present invention further provides a method of reproducing a sound source of a terminal capable of actively determining a reproduced time of the sound source through hovering, and a terminal thereof.

In accordance with an aspect of the present invention, a method of reproducing a sound source, includes detecting generation of an input; extracting at least one sampling point with respect to the input while the input continues; analyzing input information based on the at least one sampling point; determining a reproducing attribute with respect to a sound source corresponding to the input information based on the input information; and reproducing the sound source corresponding to the input information according to the determined reproducing attribute.

In accordance with another aspect of the present invention, a terminal includes an input unit configured to detect an input; a controller configured to reproduce a sound source corresponding to input information of the input; and a sound output unit configured to output a sound according to the reproducing of the sound source, wherein the controller is further configured to extract at least one sampling point with respect to the input, analyze input information based on the at least one sampling point, determine a reproducing attribute with respect to a sound source corresponding to the input information based on the input information, and reproduce the sound source corresponding to the input information according to the determined reproducing attribute.

### BRIEF DESCRIPTION OF THE DRAWINGS

The above aspects, features and advantages of the present invention will be more apparent from the following detailed description in conjunction with the accompanying drawings, in which:

FIG. 1 is a block diagram illustrating a configuration of a terminal for implementing a method of reproducing a sound source according to an embodiment of the present invention;

FIG. 2 is a flowchart illustrating a method of reproducing a sound source according to an embodiment of the present invention;

FIG. 3 is a diagram illustrating an example of linked inputs;

FIG. 4 is a flowchart illustrating a method of reproducing a sound source corresponding to generation of an input according to an embodiment of the present invention;

FIG. 5 is a diagram illustrating an example of a detected input;

FIG. 6 is a diagram illustrating an example of an extracted result of a sampling point;

FIG. 7 is a diagram illustrating an example of a scheme analyzing an input angle;

FIG. 8 is a diagram illustrating an example of changing a frequency attribute of a sound source;

FIG. 9 is a diagram illustrating an example of changing a volume attribute of a sound source;

FIG. 10 is a flowchart illustrating a method of reproducing a sound source corresponding to termination of an input according to an embodiment of the present invention;

FIG. 11 is a diagram illustrating a first embodiment which reproduces a sound source according to the present invention;

FIG. 12 is a diagram illustrating a second embodiment which reproduces a sound source according to the present invention;

FIG. 13 is a diagram illustrating a third embodiment which reproduces a sound source according to the present invention;

FIG. 14 is a diagram illustrating a fourth embodiment which reproduces a sound source according to the present invention; and

FIG. 15 is a diagram illustrating a fifth embodiment which reproduces a sound source according to the present invention.

### DETAILED DESCRIPTION OF EMBODIMENTS OF THE PRESENT INVENTION

Embodiments of the present invention are described in detail with reference to the accompanying drawings. The same reference numbers are used throughout the drawings to refer to the same or like parts. Detailed descriptions of well-known functions and structures incorporated herein may be omitted to avoid obscuring the subject matter of the present invention.

The present invention is applicable to reproduce a sound source of a terminal which provides a sound source reproducing function such as an effect sound.

Further, the present invention is applicable to various devices or services using reproduction of a sound source, as well as general electronic terminals such as a smart phone, a portable terminal, a mobile terminal, a Personal Digital Assistant (PDA), a Portable Multimedia Player (PMP) terminal, a notebook computer, a Note Pad, a Wibro terminal, a smart PC, and a smart refrigerator as a terminal reproducing a sound source.

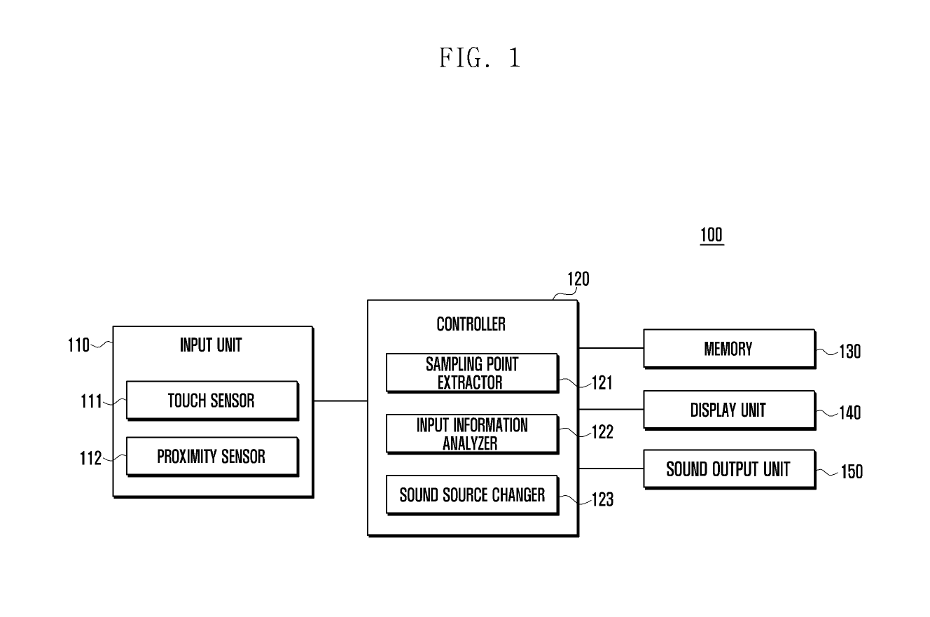

FIG. 1 is a block diagram illustrating a configuration of a terminal for implementing a method of reproducing a sound source according to an embodiment of the present invention.

Referring to FIG. 1, the terminal 100 may include an input unit 110, a controller 120, a memory 130, a display unit 140, and a sound output unit 150.

The input unit 110 receives an operation signal of a user for controlling an operation of the terminal 100, and includes a touch sensor 111 and a proximity sensor 112.

The touch sensor 111 detects a touch input of the user. The touch sensor 111 may have a type of a touch film, a touch sheet or a touch pad or may have a type of a Touch Screen Panel (TSP) in connection with the display unit 140. The touch sensor 111 detects a touch input and transfers a detected touch signal to the controller 120. The controller 140 analyzes the touch signal to perform an operation corresponding to the analyzed touch signal. Information corresponding to the detected touch signal may be displayed on the display unit 140. The touch sensor 111 receives an operation signal according to the touch input of the user by various input means. The touch sensor 111 may receive an operation signal according to a hand of the user, a physical tool, a stylus pen, and an operation button which may be included in the stylus pen.

The proximity sensor 112 detects presence, approach, motion, direction, speed, and a shape of an object occurring at a detection surface of the input unit 110 using an electromagnetic force without a mechanical contact. For example, the proximity sensor 112 may be one of a transmission photoelectric sensor, a direct reflection photoelectric sensor, a mirror reflection photoelectric sensor, a high frequency oscillating proximity sensor, a capacitive proximity sensor, a magnetic proximity sensor, and an infrared proximity sensor.

The input unit 110 may be configured to perform functions of the touch sensor 111 and the proximity sensor 112 using an Electro Magnetic Resonance (EMR) pad.

According to the embodiment of the present invention, the input unit 110 detects generation, maintenance, and termination of one of the touch input and the proximity input which are independently or sequentially generated.

According to the embodiment of the present invention, the input unit 110 detects locations (coordinates) of the touch input and the proximity input, and pressure.

The controller 120 controls an overall operation of constituent elements to operate the terminal 100. For example, the controller 120 reproduces a sound source for providing various effect sounds corresponding to the detected input from the input unit 110.

The controller 120 includes a sampling point extractor 121, an input information analyzer 122, and a sound source changer 123.

The sampling point extractor 121 extracts a sampling point with respect to the detected input from the input unit 110. The sampling point represents a generated location (coordinates) of the input. The sampling point extractor 121 extracts at least one sampling point with respect to the input while the input continues. Further, the sampling point extractor 121 extracts at least one sampling point corresponding to a preset period while the input continues.

The input information analyzer 122 analyzes input information based on the sampling point extracted by the sampling point extractor 121. For example, the input information analyzer 122 may analyze input information including at least one of input speed, an input angle, and pressure based on at least one sampling point.

The sound source changer 123 changes a reproducing attribute of a sound source stored in the memory 130 based on the input information. The sound source changer 123 determines a reproducing attribute including at least one of reproducing speed, a frequency, a volume, a reproducing start time, a reproducing termination time, and presence of repeated reproducing of the sound source based on the input information. The sound source changer 123 changes a reproducing attribute of the stored sound source according to the determined reproducing attribute. The sound source changer 123 modulates the stored sound source according to the determined reproducing attribute and may temporarily or permanently store the modulated sound source.

According to an embodiment of the present invention, the controller 120 extracts a sampling point with respect to the detected input from the input unit 110 through the sampling point extractor 121, and analyzes the input information through the input information analyzer 122. The controller 120 determines a reproducing attribute with respect to a sound source corresponding to the input and the input information based on the analyzed input information through the sound source changer 123, and reproduces the sound source according to the determined reproducing attribute.

A detailed operation of the controller 120 will be described below.

The memory 130 stores programs or commands for the terminal 100. The controller 120 performs the programs or the commands stored in the memory 130.

The memory 130 may include a storage medium having at least one type of a flash memory, a hard disk, a multimedia card micro, a memory card (for example, an SD or XD memory), RAM (Random Access Memory), SRAM (Static Random Access Memory), ROM (Read-Only Memory), EEPROM (Electrically Erasable Programmable Read-Only Memory), PROM (Programmable Read-Only Memory), MRAM (Magnetic RAM), a magnetic disc, and an optical disc.

According to an embodiment of the present invention, the memory 130 stores a sound source received from the outside or supplied upon manufacture of the terminal. The memory 130 stores sound source information associated with the sound source. The sound source information includes a title, a file size, a provider, a copy writer of the sound source, and input information corresponding to the sound source. The input information may include at least one of an input type, such as a pen or eraser input, a type of pen, color and thickness of the pen, and whether the input is a generation, maintenance, or termination input, speed and an angle of the input, and pressure.

According to an embodiment of the present invention, the memory 130 may temporarily or permanently store the sampling point extracted from the sampling point extractor 121 and a sound source changed through the sound source changer 123. The memory 130 may store data, equations, thresholds, and preset values necessary to analyze the input information or determine a reproducing attribute of the sound source.

The display unit 140 displays (outputs) information processed by the terminal 100. For example, the display unit 140 may display a User Interface (UI) or a Graphic User Interface (GUI) associated with a memo function.

According to an embodiment of the present invention, the display unit 140 may display the UI or the GUI corresponding to the detected input from the input unit 110. For example, the display unit 140 may display a track with respect to the detected input.

The display unit 140 may include at least one of a Liquid Crystal Display (LCD), a Thin Film Transistor LCD (TFT LCD), an Organic Light-Emitting Diode (OLED), a flexible display, and a 3D display.

The display unit 140 may have a mutual layer structure with a touch sensor constituting the input unit 110 and act as a touch screen. In this case, the display unit 140 acting as the touch screen performs a function of an input device.

The sound output unit 150 outputs a sound from the sound source reproduced by the controller 120. For example, if a sound source associated with a received call signal sound, a received message sound, and an effect sound is reproduced, the sound output unit 150 may output a sound caused by reproducing the sound source to the outside.

According to an embodiment of the present invention, the sound output unit 150 outputs various effect sounds corresponding to the input. For example, the sound output unit 150 may output a start sound, a frictional sound, and a termination sound reproduced by the controller 120.

Since constituent elements shown in FIG. 1 are not essential, a terminal 100 having more or less constituent elements may be implemented.

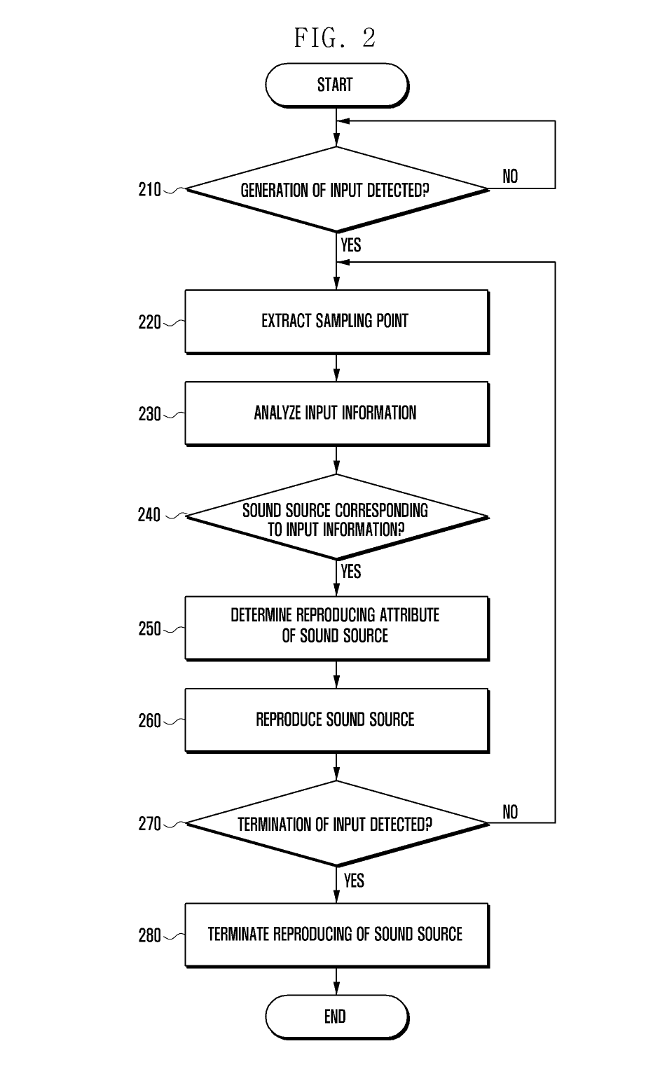

FIG. 2 is a flowchart illustrating a method of reproducing a sound source according to an embodiment of the present invention. Referring to FIG. 2, the method of reproducing the sound source may be achieved by a following sequence.

First, the terminal 100 detects generation of an input at step 210. The terminal 100 detects the generation of the input by the user. For example, the terminal 100 may detect generation of at least one of a touch input and a proximity input (referred to as hovering) which are independently or sequentially generated.

The touch input may be generated by a physical tool or a pen, and may have different control signals according to an operation button included in the pen. The proximity input may be generated by a finger, the physical tool, or the pen as it approaches the terminal 100. When an input tool makes contact with the terminal 100 or an input tool approaches within a threshold distance which the terminal 100 can recognize the approach of the input tool, the terminal 100 detects the generation of the input.

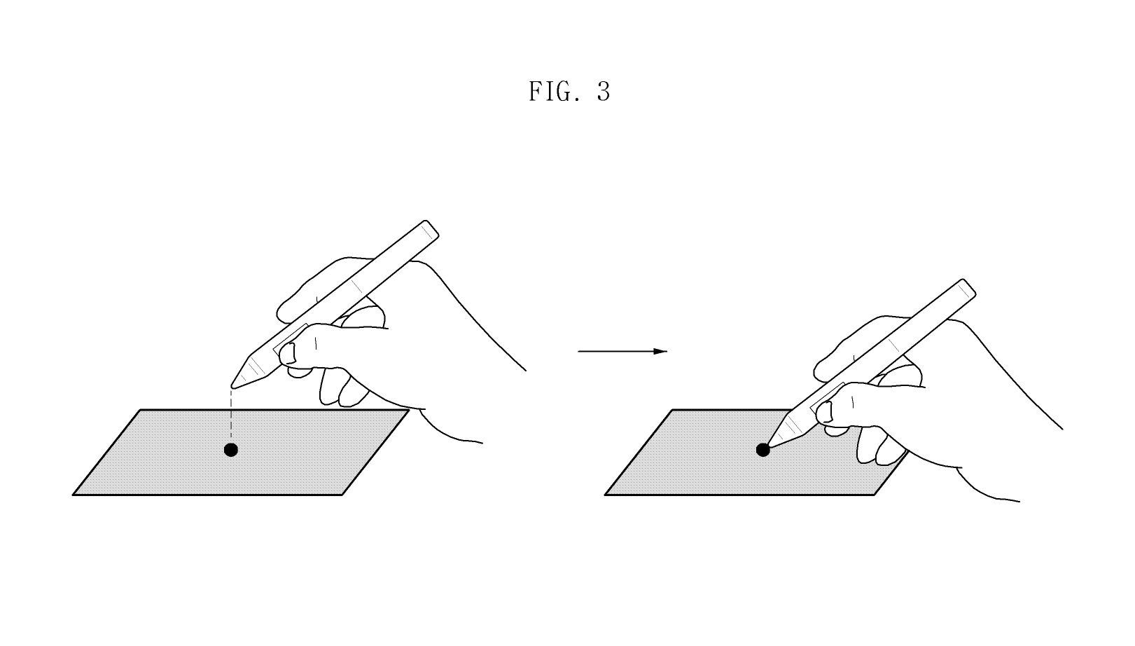

The terminal 100 may detect independently generated touch input or proximity input, and detects at least one of the touch input and the proximity input which are sequentially generated. For example, referring to FIG. 3, when a finger approaches the terminal 100 within a threshold distance to detect generation of proximity input, and the finger touches the terminal 100, the terminal 100 detects the generation of the touch input.

The terminal 100 performs an operation to be described below corresponding to one of a first detected input or a later detected input of the touch input and the proximity input which are sequentially detected.

The terminal 100 determines input information with respect to the detected input. For example, the terminal 100 detects a location of the input, a type of the input (e.g., pen or eraser input, a type of pen, color and thickness of the pen), and pressure.

Further, the terminal 100 performs an operation with respect to a sound source corresponding to the input information. For example, the terminal 100 performs preceding operations for reproducing including search, loading, and reproducing-initialization of a sound source corresponding to the input information.

In addition, the terminal 100 reproduces the sound source corresponding to the input information. In this case, the terminal 100 may reproduce the sound source corresponding to the input information with an optional volume. For example, if the proximity input is generated, the terminal 100 may reproduce the sound source corresponding to the input information of the proximity input with a volume of 0. Accordingly, although the user does not substantially touch the terminal 100, as the input approaches the terminal 100, reproduction of the sound source may be prevented from being delayed in the terminal 100 when the touch is achieved by reproducing the sound source corresponding to the proximity input in advance.

If the generation of the input is detected, the terminal 100 reproduces a sound source corresponding to the generation of the input.

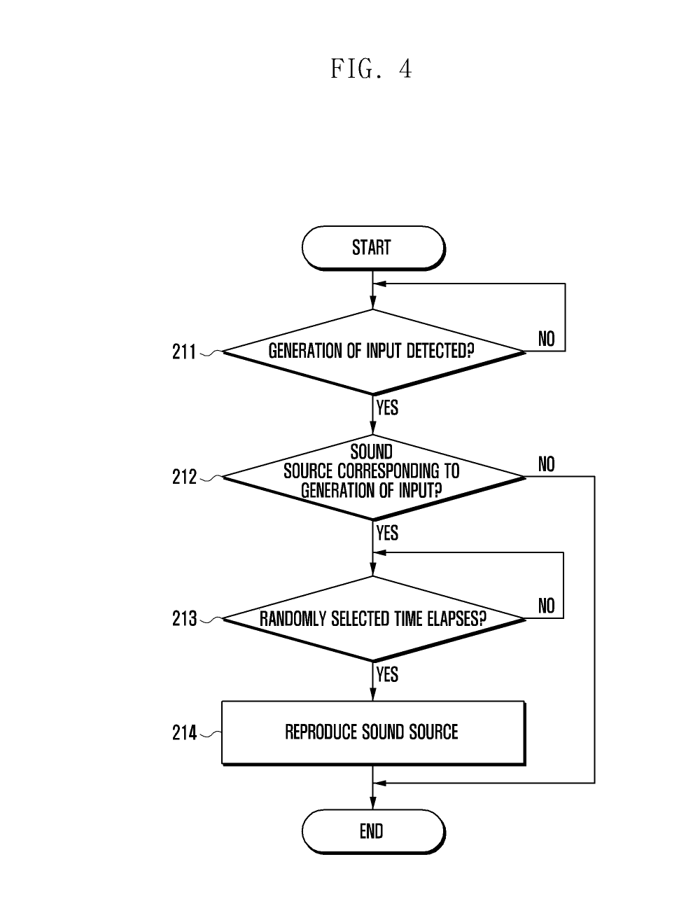

In detail, referring to FIG. 4, the terminal 100 determines whether the generation of the input is detected in step 211.

If the generation of the input is detected, the terminal 100 determines whether there is a sound source corresponding to the generation of the input in step 212. For example, the sound source corresponding to the generation of the input may be a frictional start sound.

When there is the sound source corresponding to the generation of the input, the terminal 100 reproduces the sound source corresponding to the generation of the input. The terminal 100 may reproduce the sound source corresponding to the generation of the input when the generation of the input is detected or when an optional time elapses after the generation of the input is detected.

In detail, referring to FIG. 4, the terminal 100 determines whether the optional time elapses in step 213. If the generation of the input is detected, the terminal 100 determines whether the optional time elapses.

If the optional time elapses, the terminal 100 reproduces the sound source in step 214. The optional time may be set and stored in the terminal 100 or may be a randomly selected time. The terminal 100 may determine the optional time using a function based on a detected time of the generation of the input, a generated location of the input, presence of a linked input, and application information in which the input is generated.

Regardless of whether the music reproduced corresponds to the generation of the input, the terminal 100 may extract a sampling point (to be described below) by a next operation as the generation of the input is detected. Accordingly, the terminal may reproduce music corresponding to the generation of the input simultaneously with extraction of the sampling point.

Referring back to FIG. 2, if the generation of the input is detected, the terminal 100 extracts the sampling point in step 220. The terminal 100 may extract at least one sampling point with respect to the input while the generated input continues.

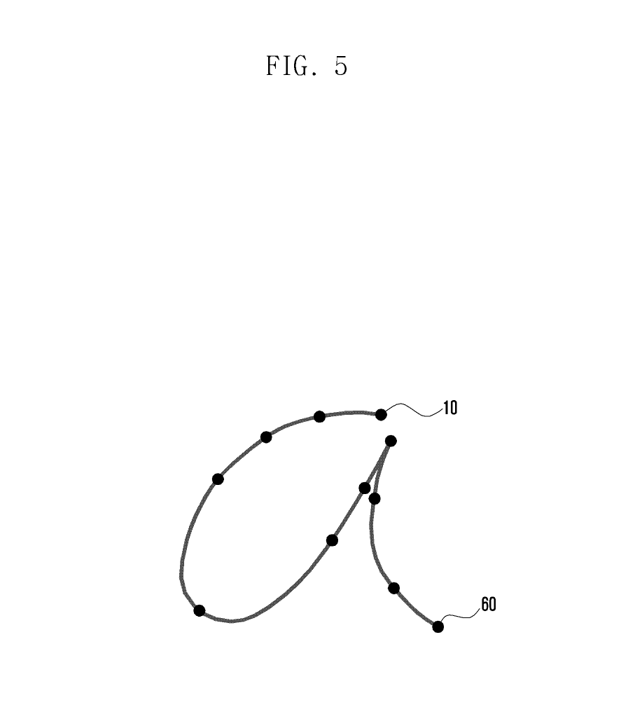

The sampling point represents a location (or coordinates) in which the input is detected. That is, referring to FIG. 5, when a user input with respect to lowercase letter “a” is generated, the terminal 100 extracts an input location at an optional moment of the sampling point while the input continues to form a track in the shape “a”.

The terminal 100 may extract at least one sampling point corresponding to a preset period. The terminal 100 may repeatedly extract the sampling point every preset time period or every frequency period. For example, the terminal 100 may extract the sampling point during a period of 60 Hz. Referring to FIG. 5, when the user input with respect the “a” is generated, the terminal 100 may extract at least one sampling point during an optional period while the input continues to form the track. As shown in FIG. 5, the terminal 100 extracts 11 sampling points for forming the track including a sampling point of an input generation start point 10 and a sampling point of a termination point 60 which is finally extracted before the input is terminated according to the generation of the input.

The input may have various input speeds and pressures according to a writing habit and a writing type, and an input track intended by the user. The extracted sampling point may have an optional interval, a relative location, and an angle according to input speed and an input track.

Next, the terminal 100 analyzes the input information in step 230. The terminal 100 analyzes the input information based on the at least one extracted sampling point. The input information may include at least one of an input type, an input location (coordinates), input speed, an input angle, and pressure.

For example, the terminal 100 may analyze an input location of the sampling point as two-dimensional coordinates or three-dimensional coordinates. The terminal 100 may present a point in which touch input is generated as the two-dimensional coordinates, or present a point in which the input is generated using a distance between the terminal 100 and the input as the three-dimensional coordinates in a case of proximity input.

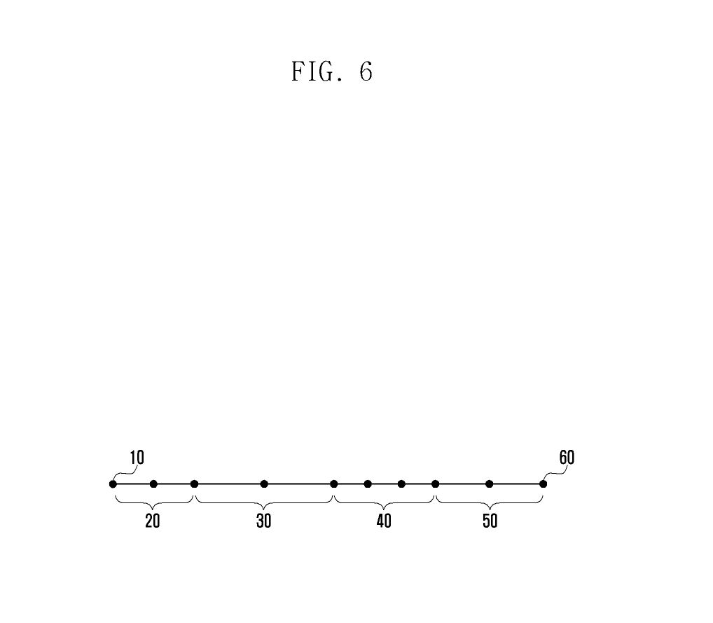

The terminal 100 analyzes the input speed based on an interval and an extracted period of the sampling point. When the extracted sampling point with respect to an input shown in FIG. 5 is arranged in a straight line, the sampling point may be represented as illustrated in FIG. 6. The sampling point may have an optional interval according to the input speed. Referring to FIG. 6, while the letter “a” is input, a track is slowly input so that an interval of the sampling point may be narrow during a first period 20 and a third period 40, and the track is rapidly input so that an interval of the sampling point may be wide during a second period 30 and a fourth period 50. The terminal 100 may analyze a straight interval of the extracted sampling point corresponding to a preset period, and may analyze the input speed based on the period and the interval. When the preset period is a frequency period f and an interval is one pixel, input speed v may be analyzed by the following Equation (1).

$$v = \frac{1}{f} \qquad Equation ( 1 )$$

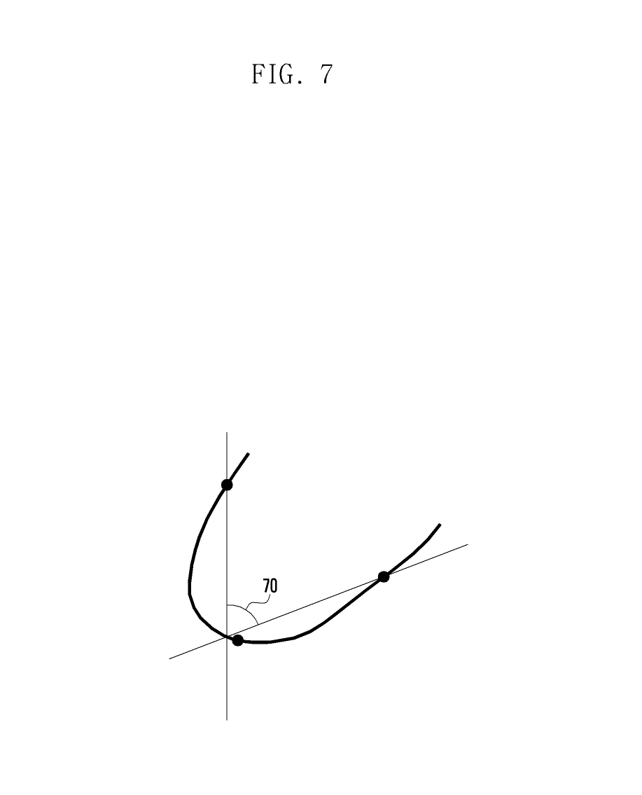

The terminal 100 may analyze the input angle based on at least three sampling points. The sampling point during the second period 30 among inputs shown in FIG. 5 may be exaggerated as shown in FIG. 7. The sampling point may have an optional relative location according to a writing habit and a writing type, and an input track intended by the user. Accordingly, an angle 70 formed by three sampling points may be determined. The terminal 100 determines the angle 70 formed by the sampling point based on the extracted sampling point. In this case, the terminal 100 determines an angle between sequentially extracted sampling points or an angle between selected sampling points at an optional interval. For example, the terminal 100 may determine the angle between the sampling points based on a reference sampling point and third and sixth extracted sampling points after the reference sampling point is extracted.

Next, the terminal 100 determines whether there is a sound source corresponding to the input information in step 240. The terminal 100 determines whether there is a sound source corresponding to the input information based on the input information. The terminal 100 may determine whether there is the sound source corresponding to the input information including at least one of an input type (e.g., pen or eraser input, a type of pen, color and thickness of the pen), an input location, input speed, an input angle, and pressure. For example, the sound source corresponding to the input information may be a frictional sound, a writing sound, and a sound of a typewriter. The sound source corresponding to the input information may be one of a plurality of sound sources modulated with respect to the same sound source to have different frequencies, volumes, and reproduced lengths according to the input speed, the input angle, and the pressure.

The terminal searches for a sound source stored in the terminal 100 or a sound source downloadable through a web server. The terminal 100 determines whether there is the sound source based on the sound source stored associated with the sound source. The sound source information includes a title, a file size, a provider, a copy writer of the sound source, and input information corresponding to the sound source.

If there is the sound source corresponding to the input information, the terminal 100 determines a reproducing attribute of the sound source in step 250.

The terminal 100 determines the reproducing attribute including at least one of reproducing speed, a frequency, a volume, a reproducing start time, a reproducing termination time, and presence of repeated reproduction with respect to the sound source corresponding to the input information.

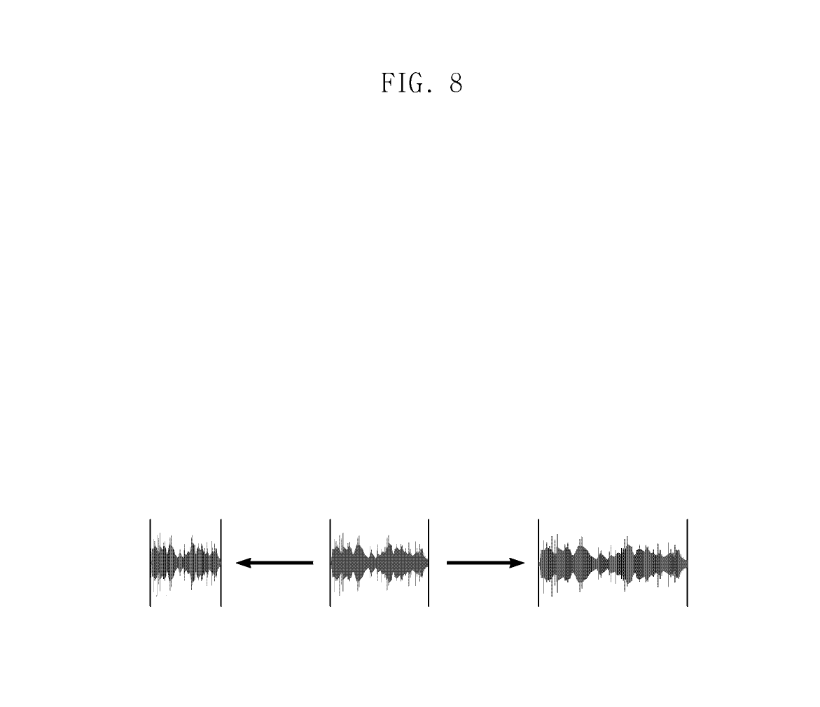

Referring to FIG. 8, the terminal 100 may increase or reduce the frequency attribute of the sound source based on the input information. For example, the terminal 100 may change the frequency attribute of the sound source based on at least one of input speed, an input angle, and pressure. When the input speed is greater than a threshold, the input angle is less than a threshold, or pressure is less than a threshold, the terminal 100 may increase the frequency of the sound source. If the frequency of the sound source is higher than the threshold, an audio pitch may become higher and reproducing speed of the sound source may become faster according to a modulation scheme of the sound source. Accordingly, the terminal 100 may rapidly reproduce the sound source according to the input information so that a more natural effect sound may be provided. Conversely, when the input speed is less than the threshold, the input angle is less than the threshold, or the pressure is less than the threshold, the terminal 100 may reduce the frequency of the sound source.

A proportional expression with respect to an example of change in the frequency as illustrated above may be expressed by the following Equation (2).

$$Frequency ∝ input speed ∝ \frac{1}{input angle} ∝ \frac{1}{pressure} \qquad Equation ( 2 )$$

The terminal 100 may determine the reproducing speed of the sound source by changing the frequency attribute of the sound source. Further, the terminal 100 may determine the reproducing attribute or use a modulation scheme for preventing the change in a volume by reflecting the change in the volume due to the change in the frequency attribute of the sound source.

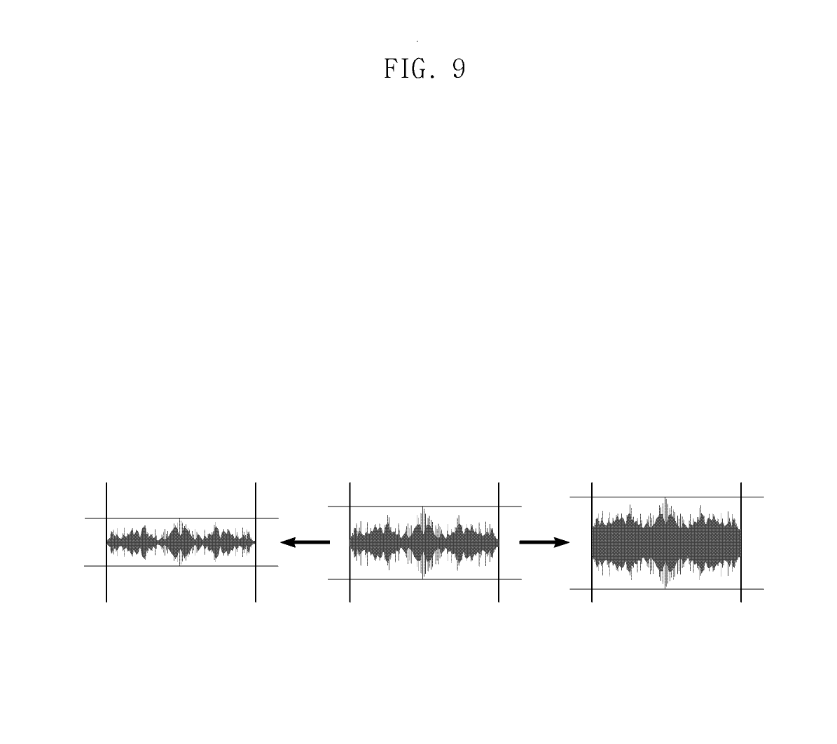

Referring to FIG. 9, the terminal 100 may increase or reduce a volume of the sound source based on the input information. For example, the terminal 100 may change a volume attribute of the sound source based on at least one of the input speed, the input angle, and the pressure. When the input speed is greater than a threshold, the input angle is less than a threshold, or the pressure is less than a threshold, the terminal may increase the volume of the sound source.

When the input speed is less than the threshold, the input angle is less than the threshold, or the pressure is less than the threshold, the terminal 100 may reduce the volume of the sound source.

A proportional expression with respect to an example of the change in the volume as illustrated above may be expressed by the following Equation (3).

$$Volume ∝ input speed ∝ \frac{1}{input angle} ∝ \frac{1}{pressure} \qquad Equation ( 3 )$$

The terminal 100 may determine whether to repeatedly reproduce the sound source while the input continues, and may determine whether to repeatedly reproduce the sound source according to a reproducing attribute determined corresponding to the input information.

The terminal 100 may modulate a sound source to optionally or permanently store the modulated sound source when the input is detected or based on a determined reproducing attribute. In this case, the terminal 100 may maintain an original sound source, and separately store the modulated sound source, and store the modulated sound source associated with the input information.

Referring back to FIG. 2, the terminal 100 reproduces the sound source in step 260. The terminal 100 reproduces the sound source according to the determined reproducing attribute. The terminal 100 modulates the sound source corresponding to the input information according to the determined reproducing attribute and reproduces the modulated sound source. The terminal 100 reproduces the modulated sound source to have the determined reproducing attribute.

When an optional time elapses after the input is detected, the terminal 100 reproduces the sound source. The optional time may be set and stored in the terminal 100 or be a randomly selected time. The terminal 100 may determine the optional time using a function based on a detected time of the input, a location of the input, and application information in which the input is generated.

The terminal 100 determines a reproducing start time based on the input information upon determination of the reproducing attribute. That is, the terminal 100 determines a reproducing start time when an optional time elapses after the input is detected. When the reproducing start time comes, the terminal 100 reproduces the sound source.

The terminal 100 may apply various effects to reproduce the sound source. For example, the terminal 100 may reproduce the sound source according to effects such as fade in, fade out, echo, and vibration. The terminal 100 may modulate the sound source so that the foregoing effects are applied to the sound source or may control input/output specifications to apply the effects.

After that, the terminal 100 determines whether termination of the input is detected in step 270. The terminal 100 detects the termination of the input by the user. For example, when the input no longer continues so that an input signal is not generated, the terminal 100 may detect that the input is terminated. For example, the terminal 100 may detect termination of at least one of a touch input and a proximity input (hovering) which are independently or sequentially generated. When an input tool no longer makes contact with the terminal 100 or the input tool is located greater than a threshold distance which the terminal 100 recognizes as the approach of the input tool, the terminal 100 detects the termination of the input.

The terminal 100 detects termination of the touch input and the proximity input which are independently or sequentially generated. The terminal 100 may perform an optional operation corresponding to one of first detected termination or later detected termination of the touch input and the proximity input which are sequentially detected.

If the termination of the input is not detected, the terminal 100 continuously extracts a sampling point, analyzes the input information to determine a reproducing attribute of the sound source, and repeatedly reproduces the sound source according to the determined attribute.

If the termination of the input is detected, the terminal 100 terminates reproduction of the sound source in step 280. If the termination of the input is detected, the terminal 100 terminates a reproduced sound source or a repeatedly reproduced sound source. In this case, when the termination of the input is detected or a randomly selected time elapses after the termination of the input is detected, the terminal 100 terminates the reproducing of the sound source. That is, the terminal 100 maintains reproduction of the sound source for the optional time although the input is terminated to remove the disconnect felt by the user when the reproducing of the sound source is suddenly terminated.

The optional time may be set and stored in the terminal 100 or may be a randomly selected time. The terminal 100 determines the optional time using a function based on a detected time of the termination of the input and application information in which the input is terminated.

In addition, the terminal 100 may perform an operation with respect to the sound source corresponding to the termination of the input. For example, the terminal 100 may reproduce the sound source corresponding to the termination of the input.

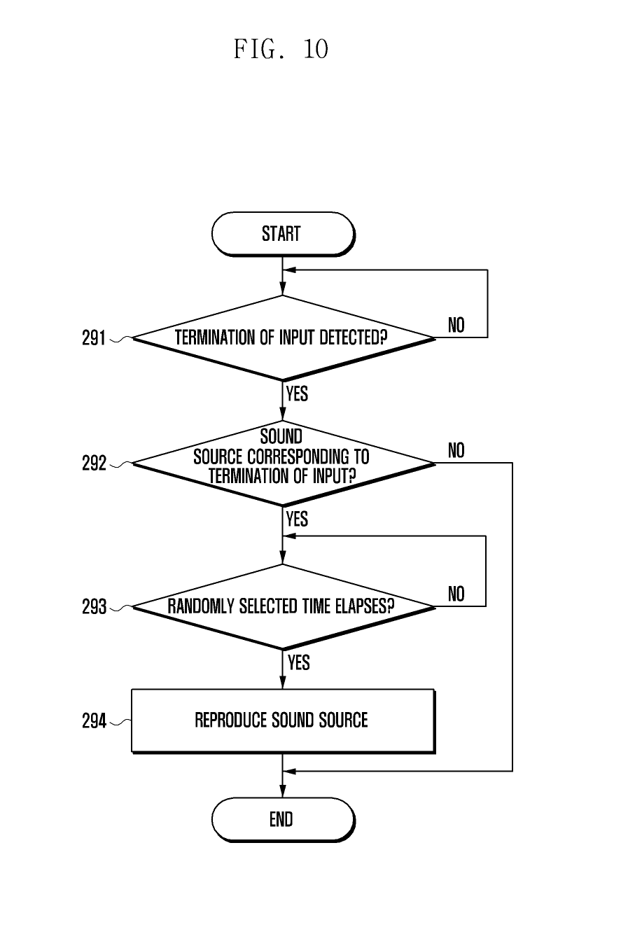

In detail, referring to FIG. 10, the terminal 100 detects the termination of the input in step 291.

If the termination of the input is detected, the terminal 100 determines whether there is a sound source corresponding to the termination of the input in step 292. For example, the sound source corresponding to the termination of the input may include a frictional termination sound.

If there is a sound source corresponding to the termination of the input, the terminal 100 reproduces the sound source corresponding to the termination of the input. When the termination of the input is detected or when an optional time elapses after the termination of the input is detected, the terminal 100 reproduces the sound source corresponding to the termination of the input.

Referring to FIG. 10, the terminal 100 may determine whether the optional time elapses in step 293. If the termination of the input is detected, the terminal 100 determines whether the optional time elapses. When the optional time elapses, the terminal 100 reproduces the sound source in step 294.

The optional time may be set and stored in the terminal 100 or may be a randomly selected time. The terminal 100 may determine the optional time using a function based on a detected time of the generation of the input, a generation location of the input, presence of a linked input, and application information in which the input is generated.

An embodiment of reproducing the sound source using the foregoing method will now be described in detail.

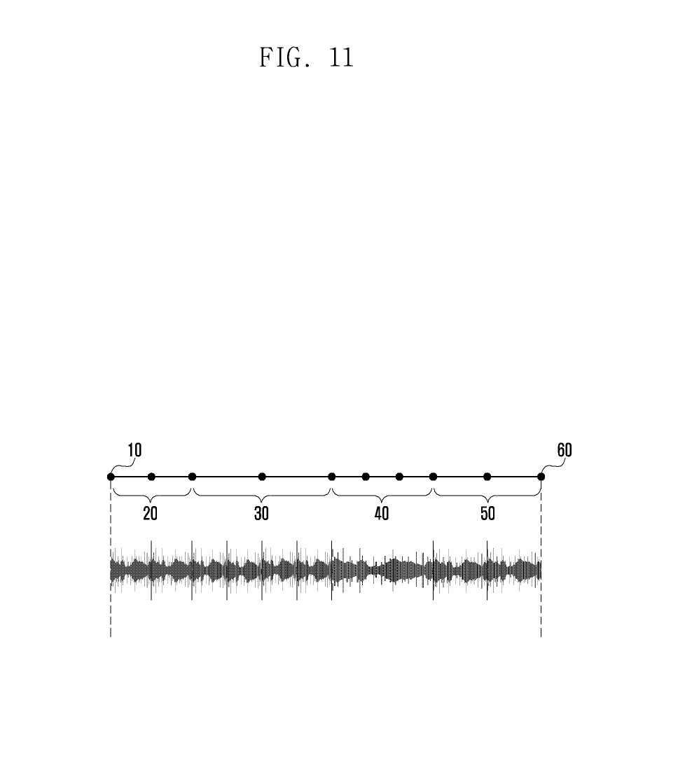

FIG. 11 is a diagram illustrating a first embodiment which reproduces a sound source according to the present invention.

Referring to FIG. 11, a terminal 100 detects generation of an input. The terminal 100 detects a touch input or a proximity input by the user. The terminal 100 determines the input information to reproduce a sound source corresponding to input information.

The terminal 100 may extract 10 sampling points for forming the track including a sampling point of an input generation start point 10 and a sampling point of a termination point 60 which is finally extracted before the input is terminated during a period according to the generation of the input while the input continues.

The terminal analyzes the input information based on the extracted sampling point. The terminal 100 may analyze input speed and an input angle based on a length between the sampling points, an angle, and pressure. For example, the terminal 100 may analyze input speed based on a narrow interval between the sampling points during a first period 20 of the extracted sampling point, and analyze input speed based on a wide interval between the sampling points during a second period 30. According to the analysis result, the input speed during the first period 20 becomes lower than that during the second period 30.

The terminal 100 determines a reproducing attribute of the sound source corresponding to the input information based on the analyzed input information. For example, the terminal 100 may increase a frequency of a sound source during the first period 20 having relatively lower input speed. Further, the terminal 100 may reduce a frequency of a sound source during the second period 30 having relatively higher input speed. The terminal 100 repeatedly reproduces the sound source according to the determined reproducing attribute, until the terminal 100 detects termination of the input. The terminal 100 terminates the reproducing of the sound source corresponding to the input according to the termination of the input.

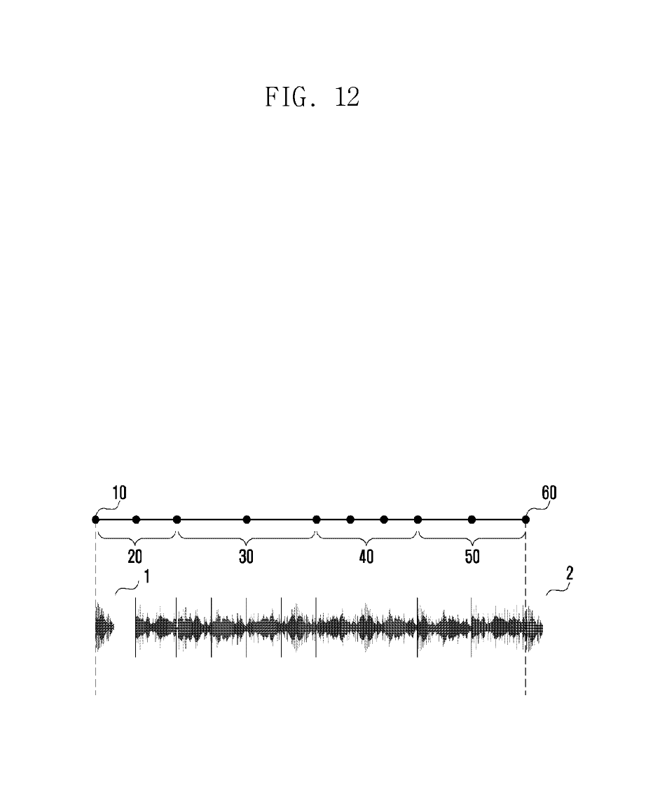

FIG. 12 is a diagram illustrating a second embodiment which reproduces a sound source according to the present invention.

Referring to FIG. 12, a terminal 100 detects generation of an input. The terminal 100 detects generation of a touch input or a proximity input by the user.

If the generation of the input is detected, the terminal 100 reproduces a sound source 1 corresponding to the generation of the input. For example, the sound source 1 corresponding to the generation of the input may include a friction start sound.

The terminal 100 may extract 11 sampling points for forming the track including a sampling point of an input generation start point 10 according to the generation of the input during a period while the input continues and a sampling point of a termination point 60 finally extracted before the input is terminated.

The terminal 100 analyzes input information based on the extracted sampling points, and determines a reproducing attribute of a sound source corresponding to the input information based on the analyzed information. The terminal 100 may repeatedly reproduce the sound source according to the determined reproducing attribute. For example, the sound source corresponding to the input information may be a frictional sound, a writing sound, and a sound of a typewriter.

The terminal 100 detects termination of the input. The terminal 100 detects termination of a touch input or a proximity input. If the termination of the input is detected, the terminal 100 terminates the reproducing of the sound source corresponding to the input according to the termination of the input. In addition, the terminal 100 may terminate the reproducing of the sound source corresponding to the input information and then reproduce the sound source 2 corresponding to the termination of the input. For example, the sound source 2 corresponding to the termination of the input may include a frictional termination sound.

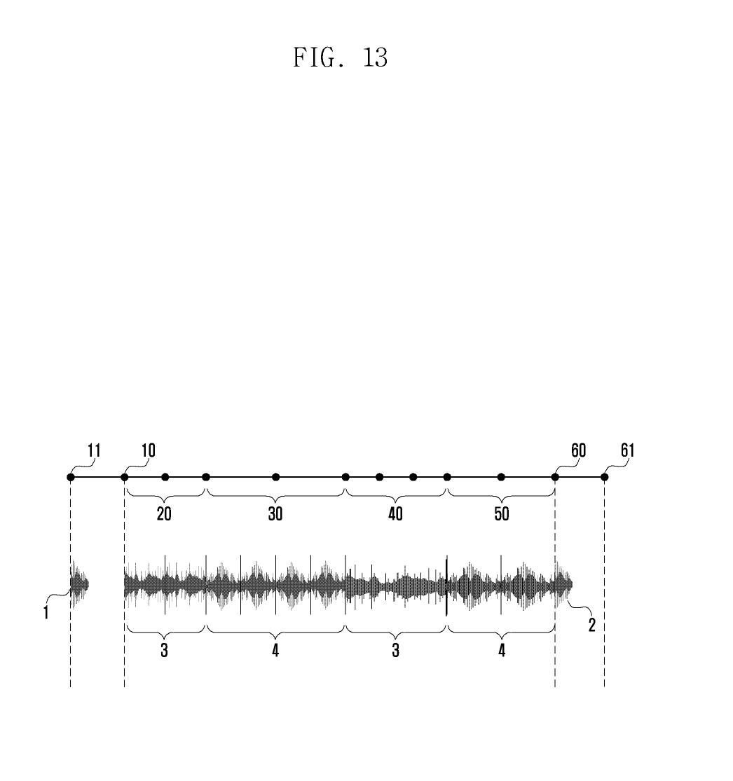

FIG. 13 is a diagram illustrating a third embodiment which reproduces a sound source according to the present invention.

Referring to FIG. 13, the terminal 100 detects generation of the input. The terminal 100 detects generation of linked inputs in which touch inputs are sequentially generated after the proximity input.

If generation of the proximity input is detected, the terminal 100 reproduces a sound source 1 corresponding to the generation of the input. If sequential generation of touch input is detected after generation of the proximity input, the terminal 100 reproduces the sound source 1 corresponding to the generation of the input.

The terminal 100 extracts a plurality of sampling points of a proximity input generation point 11 and a touch input generation point 10 while linked touch inputs continue after detection of the proximity input.

The terminal 100 analyzes input information based on the extracted sampling point, and determines whether there is a sound source corresponding to the input information based on the analyzed input information. When there is a sound source, the terminal reproduces a corresponding sound source. For example, the terminal 100 may reproduce a first sound source 3 during a first period 20 having relatively lower input speed, and may reproduce a second source 4 during a second period having relatively higher input speed.

The terminal 100 detects termination of the input. The terminal 100 detects termination of linked inputs in which proximity input is terminated after the terminal 100 terminates the touch input. The terminal 100 terminates the reproducing of the sound source corresponding to the input information according to the termination of the input. The terminal 100 may terminate reproducing of the sound source corresponding to the input information when termination of the touch input or the proximity input is detected.

The terminal 100 terminates the reproducing of the sound source corresponding to the input information, and may reproduce a sound source 2 corresponding to the termination of the input. The terminal 100 reproduces the sound source 2 corresponding to the termination of the input when termination of the touch input or the proximity input is detected.

Since reproducing of a start sound and a termination sound according to detection of input generation or termination upon the generation of the linked inputs may be variously changed according to an embodiment of the present invention, the reproducing time point or the termination time point of the sound source is not limited to the foregoing example.

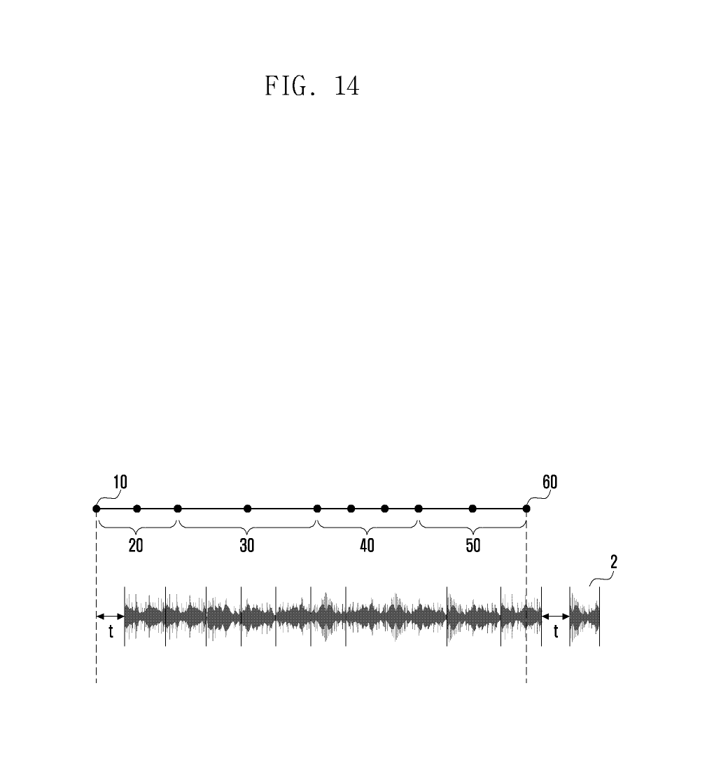

FIG. 14 is a diagram illustrating a fourth embodiment which reproduces a sound source according to the present invention.

Referring FIG. 14, the terminal 100 detects generation of the input. The terminal 100 detects generation of a touch input or a proximity input by the user.

The terminal 100 extracts at least one sampling point while the input continues, and analyzes the input information based on the extracted sampling point.

The terminal 100 determines a reproducing attribute of a sound source corresponding to the input information based on the analyzed input. The terminal 100 may determine a reproducing attribute including at least one of reproducing speed, a frequency, a volume, a reproducing start time, a reproducing termination time of the sound source, and presence of repeated reproducing based on the input information. For example, the terminal 100 may increase a frequency of a sound source during the first period 20 having relatively lower input speed. Further, the terminal 100 may reduce a frequency of a sound source during the second period 30 having relatively higher input speed. The terminal 100 may repeatedly reproduce a sound source according to the determined reproducing attribute.

In this case, the terminal 100 reproduces a sound source corresponding to generation of the input when an optional time t elapses after the generation of the input is detected. The optional time t may be set and stored in the terminal 100 or be a randomly selected time. The terminal 100 determines the optional time using a detected time of the input generation and a generated location of the input.

The terminal 100 detects the termination of the input. The terminal 100 terminates the reproducing of the sound source corresponding to the input information according to termination of the input. In this case, the terminal 100 terminates the reproducing of the sound source when the optional time elapses after the termination of the input is detected. The terminal 100 may continue the reproducing of the sound source for the optional time after the input is terminated.

The terminal 100 terminates a reproducing termination time upon determination of the reproducing attribute, and terminates the reproducing of the sound source at the determined reproducing termination time. In this case, the reproducing termination time may be a time when the optional time t elapses after the termination of the input is detected.

The terminal 100 terminates the reproducing of the sound source corresponding to the input information, and reproduces a sound source 2 corresponding to the termination of the input. In this case, the terminal 100 reproduces the sound source 2 corresponding to the termination of the input when the optional time is elapses after the termination of the input is detected. The optional time is as illustrated above.

Since reproducing of a start sound and a termination sound according to detection of input generation or termination may be variously changed according to the embodiment, the reproducing time point or the termination time point of the sound source is not limited to the foregoing example.

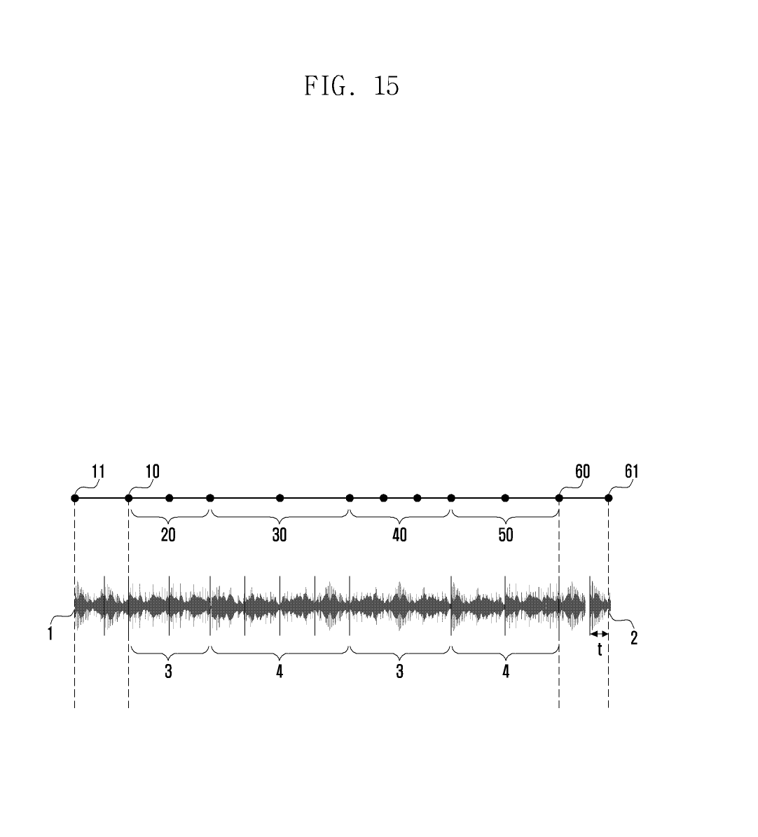

FIG. 15 is a diagram illustrating a fifth embodiment which reproduces a sound source according to the present invention.

Referring to FIG. 15, a terminal 100 detects generation of an input. The terminal 100 detects generation of linked inputs in which touch input is sequentially generated after a proximity input.

If the generation of the proximity input is detected, the terminal 100 reproduces a sound source 1 corresponding to the generation of the input. If generation of sequential touch inputs is detected after the generation of the proximity input, the terminal 100 reproduces the sound source 1 corresponding to the generation of the input.

The terminal 100 extracts a plurality of sampling points of a proximity input generation point 11 and a touch input generation point 10 while linked touch inputs continue after detection of the proximity input.

The terminal 100 analyzes input information based on the extracted sampling point.

The terminal 100 determines whether there is a sound source corresponding to the input information based on the analyzed input information. When there is the sound source, the terminal may reproduce a corresponding sound source. For example, the terminal 100 reproduces a first sound source 3 during a first period 20 having relatively lower input speed, and may reproduce a second sound source 4 during a second period having relatively higher input speed.

The terminal 100 detects termination of the input. The terminal 100 detects termination of linked inputs in which proximity input is terminated after the terminal 100 terminates the touch input. The terminal 100 terminates the reproducing of the sound source corresponding to the input information according to the termination of the input. The terminal 100 may terminate reproducing of the sound source corresponding to the input information when termination of the touch input or the proximity input is detected.

The terminal 100 terminates the reproducing of the sound source corresponding to the input information, and may reproduce a sound source 2 corresponding to the termination of the input. The terminal 100 reproduces the sound source 2 corresponding to the termination of the input when termination of the touch input or the proximity input is detected. The terminal 100 may reproduce a sound source 2 corresponding to termination of the input prior to an optional time after termination of the proximity input is detected. That is, the terminal 100 determines a termination time of the proximity input based on termination of the touch input or reproduces a sound source corresponding to termination of the proximity input before the termination of the proximity input is detected.

Since reproducing of a start sound and a termination sound according to detection of input generation or termination upon the generation of the linked inputs may be variously changed according to the embodiment, the reproducing time point or the termination time point of the sound source is not limited to the foregoing example.

The method of reproducing a sound source of a terminal and a terminal thereof according to the present invention provides an effect which the user can intuitively feel by reproducing a sound source so that one sound source corresponds to a writing track by an input.

The method of reproducing a sound source of a terminal and a terminal thereof according to the present invention ensures real time provision of the effect sound and removes the disconnect between the input and the effect sound by minimizing delay of the effect sound upon writing by the input.

Although embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method of reproducing a sound source, the method comprising:
detecting generation of an input;
extracting at least one sampling point with respect to the input while the input continues;
analyzing input information based on the at least one sampling point;
determining a reproducing attribute with respect to a sound source corresponding to the input information based on the input information; and
reproducing the sound source corresponding to the input information according to the determined reproducing attribute.

2. The method of claim 1, wherein the input is one of a touch input and a proximity input which are independently or sequentially generated.

3. The method of claim 1, wherein detecting generation of the input comprises performing at least one of a search, loading, reproducing initialization, and reproducing with an optional volume of the sound source in response to the input.

4. The method of claim 1, wherein detecting generation of the input comprises:
determining whether there is a sound source corresponding to the generation of the input; and
when there is the sound source corresponding to the generation of the input, reproducing the sound source corresponding to the generation of the input when the generation of the input is detected or when an optional time elapses after the generation of the input is detected.

5. The method of claim 1, wherein extracting at least one sampling point comprises extracting the at least one sampling point corresponding to a preset period.

6. The method of claim 1, wherein analyzing input information comprises analyzing at least one of an input type, input speed, an input angle, and pressure based on the at least one sampling point.

7. The method of claim 1, wherein determining reproducing attribute comprises:
determining whether there is a sound source corresponding to the input information; and
when there is the sound source corresponding to the input information, determining the reproducing attribute including at least one of reproducing speed, a frequency, a volume, a reproducing start time, a reproducing termination time, and presence of repeated reproducing with respect to the sound source corresponding to the input information.

8. The method of claim 1, wherein reproducing the sound source corresponding to the input information comprises reproducing the sound source when an optional time elapses after the input is detected.

9. The method of claim 1, further comprising:
detecting termination of the input; and
terminating the reproduction of the sound source corresponding to the input information.

10. The method of claim 9, wherein terminating reproduction of the sound source comprises terminating reproduction when an optional time elapses after the termination of the input is detected.

11. The method of claim 9, further comprising:
determining whether there is a sound source corresponding to the termination of the input; and
when there is the sound source corresponding to the termination of the input, reproducing the sound source when termination of the input is detected or when an optional time elapses after the termination of the input is detected.

12. A terminal comprising:
an input unit configured to detect an input;
a controller configured to reproduce a sound source corresponding to input information of the input; and
a sound output unit configured to output a sound according to the reproducing of the sound source,
wherein the controller is further configured to extract at least one sampling point with respect to the input, analyze input information based on the at least one sampling point, determine a reproducing attribute with respect to a sound source corresponding to the input information based on the input information, and reproduce the sound source corresponding to the input information according to the determined reproducing attribute.

13. The terminal of claim 12, wherein the input unit is further configured to detect one of generation, continuance, and termination with respect to one of a touch input and a proximity input which are independently or sequentially generated.

14. The terminal of claim 12, wherein the controller is further configured to perform at least one of a search, loading, reproducing initialization, and reproducing with an optional volume of the sound source corresponding to the input information when generation of the input is detected through the input unit.

15. The terminal of claim 12, wherein the controller analyzes the input information including at least one of input speed, an input angle, and pressure based on the at least one sampling point.

16. The terminal of claim 12, wherein the controller determines the reproducing attribute including at least one of reproducing speed, a frequency, a volume, a reproducing start time, a reproducing termination time, and presence of repeated reproducing with respect to the sound source corresponding to the input information.

17. The terminal of claim 12, wherein the controller reproduces the sound source corresponding to the input information or terminates the reproducing of the sound source when an optional time elapses after generation or termination of the input is detected.

18. The terminal of claim 12, wherein the controller is further configured to terminate the reproducing of the sound source corresponding to the input information when termination of the input is detected through the input unit.
